(19) United States
(12) Patent Application Publication
(10) Pub. No.: US 2016/0271666 A1
(43) Pub. Date: Sep. 22, 2016

(54) FLAT JET NOZZLE, AND USE OF A FLAT JET NOZZLE

(71) Applicant: Tobias HUBER, Metzingen (DE)

(72) Inventor: Tobias HUBER, Metzingen (DE)

(21) Appl. No.: 15/068,919

(22) Filed: Mar. 14, 2016

(30) Foreign Application Priority Data
Mar. 16, 2015 (DE) 10 2015 204 664.8

(51) Int. Cl. B21B 45/08; B08B 3/02

(52) U.S. Cl. CPC B21B 45/08; B08B 3/022

(57) ABSTRACT

A flat jet nozzle for removing material or soil with a high-pressure liquid jet at a pressure range of more than 100 bar, having a nozzle housing, and a jet director disposed in the nozzle housing. The nozzle housing forms a fluid duct having an exit opening, and the fluid duct up to the exit opening is configured so as to be concentric with a longitudinal central axis of the nozzle housing. The exit opening has an elongate shape with a comparatively long main axis and a comparatively short subsidiary axis. A plane, in which the comparatively long main axis lies and which is disposed so as to be perpendicular to the comparatively short subsidiary axis, intersects the longitudinal central axis and in relation to the longitudinal central axis encloses an angle between 5° and 75°, in particular 10° to 45°.

### CROSS-REFERENCE TO RELATED APPLICATIONS

This claims priority from German Patent Application No. 10 2015 204 664.8, filed on Mar. 16, 2015, the disclosure of which is hereby incorporated by reference in its entirety into this application.

### FIELD, BACKGROUND AND SUMMARY OF THE INVENTION

The invention relates to a flat jet nozzle for removing material or soil by means of a high-pressure liquid jet at a pressure range of more than 100 bar, having a nozzle housing, wherein the nozzle housing forms a fluid duct having an exit opening, wherein the fluid duct up to the exit opening is configured so as to be concentric with a longitudinal central axis of the nozzle housing, and wherein the exit opening has an elongate shape having a comparatively long main axis and a comparatively short subsidiary axis.

By way of the invention, a flat jet nozzle which in terms of the space requirement thereof and the application purpose thereof is to be more flexible is to be provided.

In a flat jet nozzle according to the invention for removing material or soil by means of a high-pressure liquid jet at a pressure range of more than 100 bar, having a nozzle housing, wherein the nozzle housing forms a fluid duct having an exit opening, wherein the fluid duct up to the exit opening is configured so as to be concentric with a longitudinal central axis of the nozzle housing, and wherein the exit opening has an elongate shape having a comparatively long main axis and a comparatively short subsidiary axis it is thus provided according to the invention that a plane in which the comparatively long main axis lies and which is disposed so as to be perpendicular to the comparatively short subsidiary axis intersects the longitudinal central axis and in relation to the longitudinal central axis encloses an angle between 5° and 175°, in particular 5° to 75°, in particular 10° to 45°. The elongate exit opening is thus disposed so as to be obliquely downward, perpendicular, or obliquely upward in relation to the longitudinal central axis, and consequently a plane of the flat jet that thus lies so as to be approximately centric within the delivered flat jet is also disposed so as to be oblique or perpendicular to the longitudinal central axis, intersecting the longitudinal central axis. An arrangement which is obliquely downward, having an angle between 5° and 75° is preferable for descaling steel components in rolling mills. An angle between 5° and 175° may be selected for cleaning purposes or for roughing surfaces. The plane of the delivered flat jet thus need not necessarily correspond to that plane in which the comparatively long main axis lies and which is disposed so as to be perpendicular to the comparatively short subsidiary axis. The actual exit plane of the flat jet is not only determined by the arrangement of the exit opening but moreover also by the configuration and above all the incident flow of the fluid duct up to the exit opening. The substantial advantage of the nozzle according to the invention is that a flat jet exiting in an oblique manner to the longitudinal central axis is provided and the fluid duct up to the exit opening is nevertheless configured so as to be concentric with the longitudinal central axis. The flat jet nozzle according to the invention may thus be routed through even small free spaces, for example between conveying shafts in rolling mills, in an extremely space-saving manner. Surprisingly, a very positive spray pattern of the flat jet, having a great impact or a heavy impact pulse of the flat jet on a surface being sprayed, results here even in the oblique arrangement according to the invention of the exit opening in relation to the longitudinal central axis. It has previously been assumed that in the case of high-pressure flat jet nozzles routing of the liquid through the fluid duct in as concentric a manner as possible and also a concentric arrangement of the exit opening is required in order to achieve a satisfactory spray pattern having sufficient impact. Therefore, conventional flat jet nozzles which spray in an oblique manner were configured such that the fluid duct was embodied as a kinked tube, such that a significant section having a fluid duct which is configured so as to be concentric with the longitudinal central axis of the exit opening was available upstream of the exit opening. Surprisingly, the nozzle according to the invention enables a very positive spray pattern having a very good impact across the impinged area to be achieved at an angle of the exit opening in relation to the longitudinal central axis between 5° and 75°, in particular 10° to 45°. Good results are also achieved at an angle between 5° and 175°. As has been set forth, the angle of the plane of the delivered flat jet here does not necessarily correspond to the plane of the exit opening or to the plane in which the comparatively long main axis lies and which is disposed so as to be perpendicular to the comparatively short subsidiary axis. The desired exit angle of the flat jet may however be readily calculated and set by way of computations or experiments.

In a refinement of the invention, the exit opening is disposed in an end portion of the fluid duct, having a spherical-segment shape.

The exit opening is created for example by cutting a spherical-segment shaped end portion of the fluid duct. Cutting here may be understood to mean that the nozzle housing is actually cut by means of a milling cutter; however, it may also be understood to mean that cutting may be used in the geometric sense, that is to say that the nozzle is produced by way of other methods, for example by injection moulding or sintering or casting. The arrangement of the exit opening in an end portion of the fluid duct, having a spherical-segment shape, has the significant advantage that the exit opening may be disposed at dissimilar angles in relation to the longitudinal central axis, without having to modify the end portion.

In a refinement of the invention, the exit opening has an elliptic or near-elliptic shape.

It has been established that very positive spray patterns of the delivered flat jet may be achieved with a great impact of the flat jet in the case of an elliptic shaped or a near-elliptic shaped shape in the nozzle according to the invention.

The flat jet nozzle according to the invention is preferably used for descaling metal parts.

In the descaling of metal parts by means of a water jet it is typically required that the flat jet impacts the metal surface to be descaled in a slightly oblique manner. This may also be achieved in the case of the nozzle according to the invention when the housing of the flat jet nozzle and especially the longitudinal central axis of the nozzle housing are disposed so as to be perpendicular to the surface to be descaled. On account thereof, the flat jet nozzle according to the invention may be disposed in an extremely space-saving manner.

In a refinement of the invention, a first rotation movement of the flat jet nozzle about a first rotation axis which is disposed so as to be perpendicular to a surface of the metal parts to be descaled and so as to be spaced apart from the longitudinal central axis of the nozzle housing is provided in the use according to the invention.

Improved descaling may be achieved by way of a smart selection of the rotation movements of the flat jet nozzle.

In a refinement of the invention, a second rotation movement of the flat jet nozzle about a second rotation axis is provided, wherein the second rotation axis is disposed so as to be spaced apart from the first rotation axis and so as to likewise be perpendicular to a surface of the metal parts to be descaled.

Further improvement in descaling may be achieved by the superimposition of two rotation movements of the flat jet nozzle.

In a refinement of the invention, the second rotation axis coincides with the longitudinal central axis of the nozzle housing.

According to the use according to the invention, the flat jet nozzle thus rotates about itself once, that is to say rotates about the longitudinal central axis of the nozzle housing thereof, and moreover the nozzle housing is yet rotated about a rotation axis which is disposed so as to be spaced apart from the longitudinal central axis of the nozzle housing. A superimposed rotation movement is thus created. Advantageously, a plurality of flat jet nozzles according to the invention are disposed above the surface to be descaled and rotated in a tuned manner about the first and second rotation axis, respectively, such that the surface to be descaled is completely descaled by the flat jets generated.

In a refinement of the invention, the surface to be descaled in relation to the flat jet nozzle is moved in an indexing direction which is parallel with the surface, wherein the first rotation movement and the second rotation movement are mutually adapted such that the flat jet generated by the flat jet nozzle is always disposed at a constant angle of 0° to ±45°, in particular so as to be perpendicular, to the indexing direction.

The flat jet generated by the flat jet nozzle, or the flat jets generated by a plurality of flat jet nozzles thus always impact the surface to the descaled such that a comparatively large transverse dimension of the flat jets is always disposed at a constant angle, in particular so as to be perpendicular, to the indexing direction. The impact area of the flat jets is elongate, and the comparatively long transverse dimension thereof is thus for example disposed so as to be perpendicular to the displacement direction, whereas the comparatively short transverse direction is then disposed so as to be parallel with the indexing direction. On account thereof, maximum coverage of the surface is achieved. Advantageously, the generated flat jets moreover always impact the surface to be descaled at a predefined and constant angle. Optimal conditions for descaling a surface thus always prevail, even during rotation of the flat jet nozzle or of the plurality of flat jet nozzles.

Apart from descaling metal parts, the flat jet nozzle according to the invention may of course be used in general for removing material or soil by means of a high-pressure liquid jet.

### BRIEF DESCRIPTION OF THE DRAWINGS

Further features and advantages of the invention are derived from the claims and from the following description of preferred embodiments of the invention in conjunction with the drawings. In the drawings:

FIG. 1 shows a sectional view of a flat jet nozzle according to the invention, a longitudinal central axis of the nozzle housing lying in the sectional plane;

FIG. 2 shows a side view of a mouthpiece of the flat jet nozzle of FIG. 1;

FIG. 3 shows a plan view of the mouthpiece of FIG. 2;

FIG. 4 shows a view onto the sectional plane B-B in FIG. 2;

FIG. 5 shows a view onto the sectional plane A-A in FIG. 3;

FIG. 6 shows a plan view of an arrangement of a plurality of flat jet nozzles according to the invention above a surface to be descaled, in a schematic illustration; and

FIG. 7 schematically and in portions shows an illustration for the flat jet nozzle according to the invention, for clarification of the geometric conditions.

### DETAILED DESCRIPTION

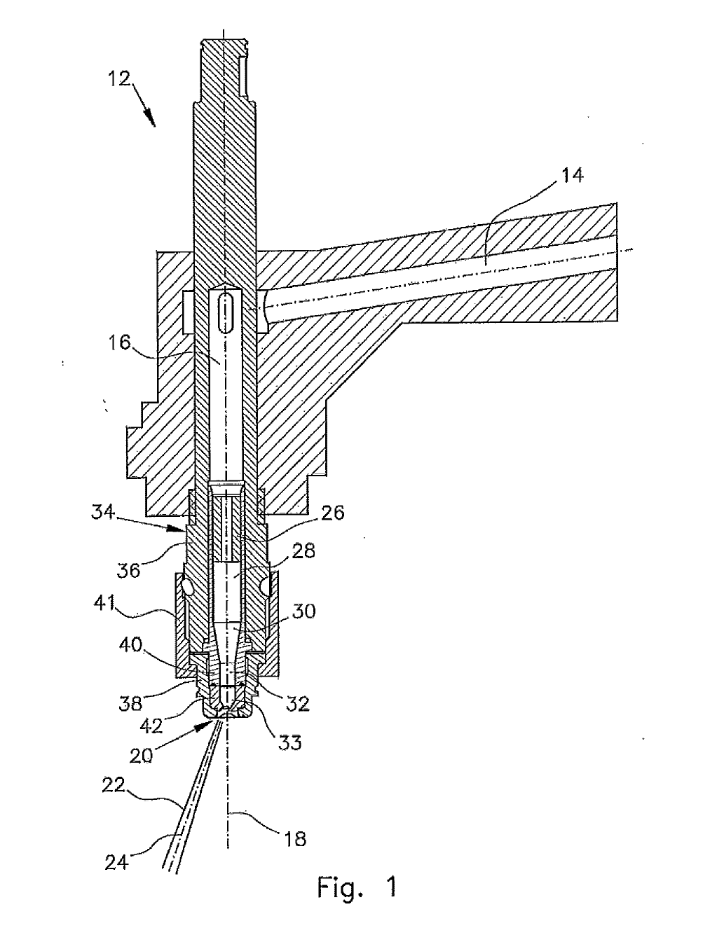

The illustration of FIG. 1 shows a flat jet nozzle 10 according to the invention, the housing of which is disposed in a mounting 12. A high-pressure liquid, for example water, is supplied through the mounting 12. The high-pressure liquid is supplied by way of a supply duct 14 which opens into a fluid duct 16 of the flat jet nozzle 10. The fluid duct 16 is disposed so as to be concentric with a longitudinal central axis 18 of the flat jet nozzle 10 according to the invention. As can be derived from FIG. 1, the fluid duct up to an exit opening 20 runs so as to be concentric with the longitudinal central axis 18. Only the exit opening 20 is disposed so as to be oblique to the longitudinal central axis such that the flat jet 22 generated by the flat jet nozzle 10 exits in a manner oblique to the longitudinal central axis 18. An exit plane of the flat jet 22 in FIG. 1 is illustrated with a chain-dotted line, using the reference sign 24. The exit plane 24 is centric in relation to the exiting flat jet and is likewise disposed so as to be oblique to the longitudinal central axis 18. The exit plane 24 intersects the longitudinal central axis 18.

Proceeding from the mouth of the supply duct 14, the fluid duct 16 initially runs along approximately half of the total length thereof having a constant diameter. A jet director 26 is disposed in the fluid duct 16 approximately halfway along the total length of said fluid duct 16. The jet director 26 has a plurality of flow directing faces which extend in a manner radial to the longitudinal central axis 18 and run parallel with the longitudinal central axis. The jet director 26 is embodied as a so-called coreless jet director such that a region about the longitudinal central axis 18 thus remains free of installations. The jet director 26 is press-fitted in a sleeve 40.

A cylindrical portion 28 of approximately the same length of the jet director 26 and diameter of the jet director 26, which is formed by the sleeve 40 adjoins the jet director 26 immediately downstream thereof. A first truncated-cone shaped diminution 30 of the fluid duct 16 follows the cylindrical portion 28. This diminution 30 of the fluid duct is followed by a cylindrical portion 32 which continues the diameter of the fluid duct that is present at the end of the diminution 28 up to an end portion of the fluid duct 16, the exit opening 20 then being disposed in the end portion. Yet a further truncated-cone shaped diminution 33 is provided ahead of the exit opening 20. The end portion is provided in portions by the second diminution 33. The exit opening 20 may be situated in a spherical-segment shaped region which adjoins the diminution 33.

The fluid duct 16 is configured within a nozzle housing 34 which, as has been set forth, is fastened to the mounting 12 and has a base portion 36 which is disposed in the mounting 12, a union hood 38 which is disposed on the base portion 36, a sleeve 40 which is screwed into the union hood 38, and a nozzle mouthpiece 42 which is inserted into the union hood 38. The sleeve 40 defines the fluid duct 16 in the region of the jet director 26, of the cylindrical portion 28, of the diminution 30, and of part of the cylindrical portion 32 of the fluid duct. The nozzle mouthpiece 42 continues the cylindrical portion 32 of the fluid duct and defines an end portion of the fluid duct 16, having the exit opening 20. The union hood 38 in turn is fastened by way of a union nut 41 to the base portion 36. A seal is provided between the sleeve 40 and the nozzle mouthpiece 42.

It can be readily identified by means of FIG. 1 that the fluid duct 16 runs so as to be completely concentric with the longitudinal central axis 18 of the nozzle housing 34 of the flat jet nozzle 10. Only the exit opening 20 is disposed so as to be oblique to the longitudinal central axis 18, such that the flat jet 22 also exits in a manner oblique to the longitudinal central axis 18.

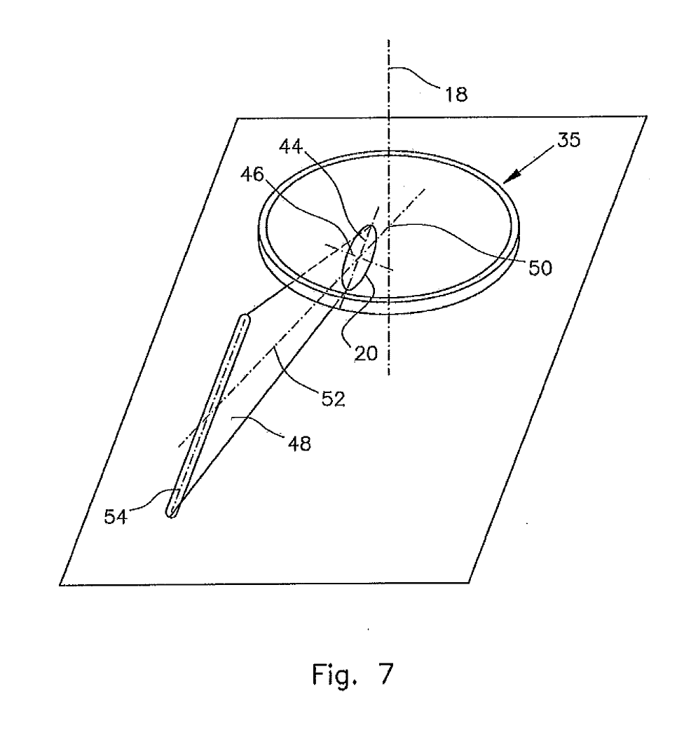

FIG. 7 schematically shows the geometric conditions in the region of the exit opening 20 which is disposed in the end portion 35 of the fluid duct. The exit opening 20 in the schematic illustration of FIG. 7 has an elliptic shape. In the context of the invention the exit opening 20 may have any elongate shape, that is to say for example be elliptic, near-elliptic, or oval. Moreover, the exit opening 20 may have an irregular elongate shape, for example a computed free-form shape.

However, the exit opening 20 always has a comparatively long main axis 44 and a comparatively short subsidiary axis 46. If the exit opening 20 has an irregular shape, the main axis 44 corresponds to a comparatively long transverse dimension of the exit opening, and the subsidiary axis 46 corresponds to a comparatively short transverse dimension of the exit opening 20.

Now, the exit opening 20 in relation to the longitudinal central axis 18 is disposed such that a plane 48 in which the comparatively long main axis 44 lies and which is disposed so as to be perpendicular to the comparatively short subsidiary axis 46 intersects the longitudinal central axis. In the illustration of FIG. 7, the plane 48 and the longitudinal central axis 18 mutually intersect at a point 50. A centreline 52 which is illustrated with a dashed line in FIG. 7 lies in the plane 48. The centreline 52 runs through the intersection point of the main axis 44 and of the subsidiary axis 46 and then also intersects the longitudinal central axis 18 at the point 50. An imaginary impact face 54 of the flat jet is indicated in the illustration of FIG. 7. This impact face 54 is divided into two halves by the plane 48. It should be recalled here that the illustration of FIG. 7 is merely schematic and that the impact face 54 in reality is not divided precisely into two halves by the plane 48. Here, the actual flow conditions in the fluid duct play a part. However, the plane 48 is defined by the main axis 44 which lies within the plane 48, and by the subsidiary axis 46 which lies on the plane so as to be perpendicular thereto. The plane 48 is thus defined by the arrangement of the exit opening 20. As has been set forth, the exit opening 20 is disposed such that the plane 48 intersects the longitudinal central axis 18 at the point 50 in the illustration of FIG. 7.

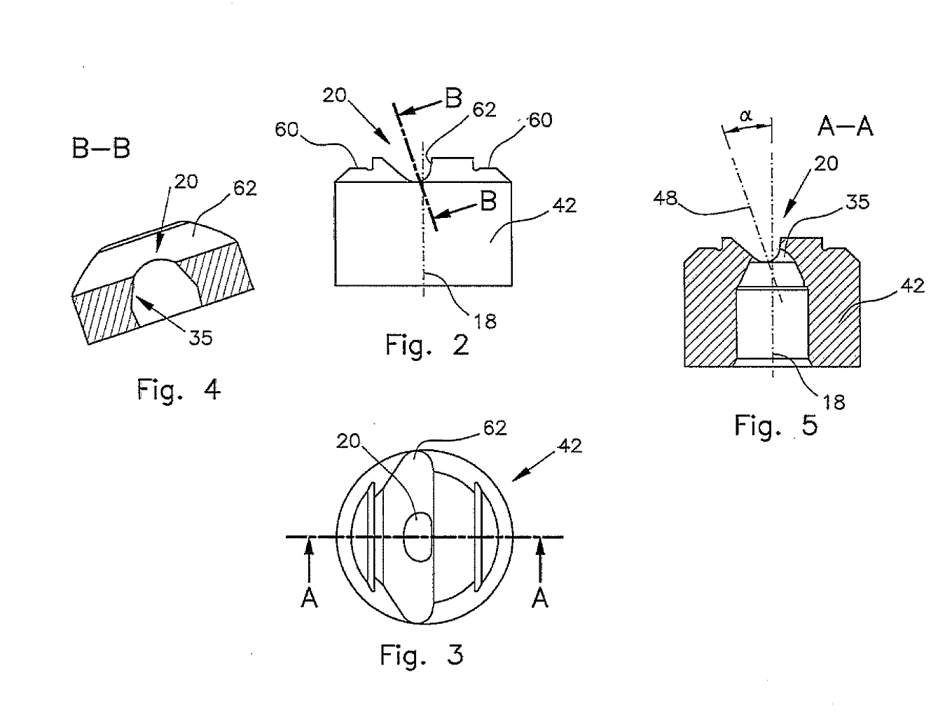

The illustration of FIG. 2 shows the nozzle mouthpiece 42 so as to be enlarged in relation to FIG. 1. The exit opening 20 lying on the top in FIG. 2 may be readily identified. The longitudinal central axis 18 of the nozzle housing is indicated with dashed lines. As can be derived from FIG. 1, the nozzle mouthpiece is push-fitted into the union hood 38. The nozzle mouthpiece 42 may be composed of hard metal, for example, sintered hard metal, for example, so as to achieve a good service life in the case of the high fluid pressures of more than 100 bar at which the flat jet nozzle according to the invention is employed.

The union hood 38 here bears on bearing faces 60 of the nozzle mouthpiece 42. The exiting liquid however does not come into contact with the union hood 38.

The nozzle mouthpiece 42 is illustrated in a view from above in FIG. 3. The exit opening 20 which in the view of FIG. 3 has the shape of an ellipse which has been flattened on one side may again be identified. This has been caused by the viewing angle of FIG. 3; the exit opening 20 is actually elliptic. The exit opening 20 is disposed within a cut duct 62 which may be identified in FIGS. 2 and 3. The exit opening 20 is created by running a milling cutter or a grinding disc in a transverse manner across the mouthpiece 42 and the latter being cut thereby.

FIG. 4 shows a view onto the sectional plane B-B in FIG. 2. The cut duct 62 and a portion of the periphery of the exit opening 20 may be identified. Furthermore, the shape of the end portion 35 of the fluid duct may be identified.

FIG. 5 shows a view onto the sectional plane A-A in FIG. 3. The longitudinal central axis 18 thus lies within the sectional plane of FIG. 5. It can be identified in the illustration of FIG. 5 that the end portion 35 of the fluid duct in which the exit opening 20 lies has a spherical-segment shape. As has been set forth by means of FIG. 7, the exit opening 20 is again disposed so as to be oblique to the longitudinal central axis 18, such that the plane 48 in relation to the longitudinal central axis encloses an angle α. This angle α may be between 5° and 75°. Particularly advantageous results have been achieved using an angle α between 10° and 45°.

In the flat jet nozzle according to the invention, the high-pressure liquid which is to be sprayed and which has a pressure of more than 100 bar is thus routed along the entire length of the fluid duct 16 so as to be concentric with the longitudinal central axis 18, cf. FIG. 1. It is only in the end portion 35 of the nozzle mouthpiece 42 that the liquid is then deflected out of the direction of the longitudinal central axis 18, cf. FIG. 5. This is performed only by the exit opening 20 being disposed so as to be oblique to the longitudinal central axis 18. Surprisingly, despite the high-pressure liquid being routed in a manner concentric with the longitudinal central axis 18 up to immediately prior to the exit opening 20, a very positive spray pattern of the delivered flat jet 22 having a great impact impulse which is uniformly distributed across the impact face results, even in the case of the exit opening 20 being disposed in a manner oblique to the longitudinal central axis 18.

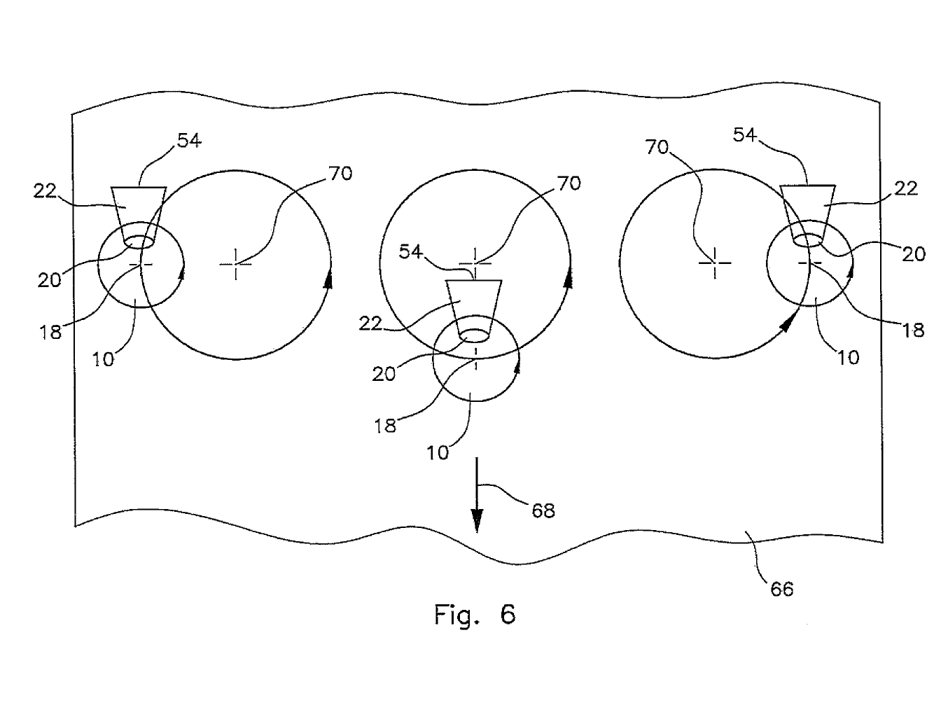

The illustration of FIG. 6 schematically shows a plurality of flat jet nozzles 10 according to the invention, wherein merely the respective longitudinal central axes 18, the exit openings 20, and the respectively delivered flat jet 22 are schematically indicated. The flat jet nozzles 10 are disposed above a surface 66 to be descaled, which in relation to the flat jet nozzles 10 is moved in the direction of an arrow 68. When employed in a rolling mill, the flat jet nozzles 10 are disposed above and below a piece of metal to be descaled. The viewing direction in FIG. 6 is from above onto the surface 66. The longitudinal central axes 18 of the flat jet nozzles 10 on the surface 66 are in each case perpendicular thereto, such that the indexing movement 68 of the surface 66 is perpendicular to the longitudinal central axes 18 of the flat jet nozzles 10. The flat jets 22 which are delivered in each case thus impact on the surface 66 in a slightly oblique manner; therefore, the flat jets 22 in the illustration of FIG. 6 are illustrated in an obliquely downward manner and directed counter to the indexing direction 68. Each of the flat jet nozzles 10 is rotated about the longitudinal central axis 18, this being indicated in each case by means of a circular arrow. Moreover, each of the flat jet nozzles 10 is rotated about a rotation axis 70 which is disposed so as to be spaced apart from the longitudinal central axis 18 of the flat jet nozzles 10. Each of the flat jet nozzles 10 thus performs two rotation movements. A first rotation movement is about the first rotation axis 70 which is disposed so as to be spaced apart from the longitudinal central axis 18 of the flat jet nozzles 10. The flat jet nozzles 10 moreover perform a second rotation movement, the second rotation axis coinciding with the longitudinal central axis 18. Both rotation axes 70, 18 are disposed so as to be perpendicular to the surface 66 to be descaled.

The two rotation movements about the rotation axis 70 and about the longitudinal central axis 18 in terms of the angular velocity of the former are mutually tuned such that the flat jets 22 irrespective of the position of the flat jet nozzles 10 are always disposed at a constant angle, in particular so as to be perpendicular, to the indexing direction 68. This is illustrated in FIG. 6. A respective impact face 54 of the flat jets 22, irrespective of the rotary position of the respective flat jet nozzle 10, is always disposed at a constant angle, in particular so as to be perpendicular, to the indexing direction 68 of the surface 66 to be descaled.

The flat jet nozzles 10 here are disposed such and the diameter of the rotation movement about the rotation axis 70 here is dimensioned such that the flat jets 22 completely descale the surface 66. To this end, of course, the amount of indexing 68 is also correspondingly tuned. The flat jets 22 thus always impact the surface 66 in a slightly oblique manner and at the predefined angle. Irrespective of the rotary position of the flat jet nozzles 10, optimal conditions for descaling of the surface 66 are thus always achieved.

The arrangement illustrated in FIG. 6 may not only be employed for descaling surfaces but also for removing material or soil from the surface 66 in general. For example, the inside of pipes or bores may be cleaned or roughened by removing material. Employment in tubular openings or in cavities in general is also possible. Of course, external faces, for example of pistons, may also be cleaned and roughened.

Apart from the arrangement shown in FIG. 6, other arrangements of a plurality of nozzles according to the invention are also possible, for example the arrangement of a plurality of rotating nozzles on a common and likewise rotating rotor, at various spacings from the rotation axis of the common rotor.

1. Flat jet nozzle for removing material or soil by means of a high-pressure liquid jet at a pressure range of more than 100 bar, having a nozzle housing, wherein the nozzle housing forms a fluid duct having an exit opening, wherein the fluid duct up to the exit opening is configured so as to be concentric with a longitudinal central axis of the fluid duct, and wherein the exit opening has an elongate shape having a comparatively long main axis and a comparatively short subsidiary axis, wherein a plane in which the comparatively long main axis lies and which is disposed so as to be perpendicular to the comparatively short subsidiary axis intersects the longitudinal central axis and in relation to the longitudinal central axis encloses an angle between 5° and 175° wherein the exit opening is shaped and arranged such that a plane of the delivered flat jet, that thus lies so as to be approximately centric within the delivered flat jet, is disposed so as to be oblique or perpendicular to the longitudinal central axis and so as to intercept the longitudinal central axis.

2. Flat jet nozzle according to claim 1, wherein the plane in relation to the central longitudinal axis encloses an angle between 5° and 75°.

3. Flat jet nozzle according to claim 2, wherein the plane in relation to the central longitudinal axis encloses an angle between 10° and 45°.

4. Flat jet nozzle according to claim 1, wherein the exit opening is disposed in an end portion of the fluid duct, having a spherical-segment shape.

5. Flat jet nozzle according to claim 1, wherein the exit opening has an elliptic or near-elliptic shape.

6. Use of a flat jet nozzle according to claim 1, for descaling metal parts.

7. Use according to claim 6, wherein a first rotation movement of the flat jet nozzle about a first rotation axis which is disposed so as to be perpendicular to a surface of the metal parts to be descaled and so as to be spaced apart from the longitudinal central axis of the fluid duct.

8. Use according to claim 7, wherein a second rotation movement of the flat jet nozzle about a second rotation axis, wherein the second rotation axis is disposed so as to be spaced apart from the first rotation axis and so as to likewise be perpendicular to a surface of the metal parts to be descaled.

9. Use according to claim 8, wherein the second rotation axis coincides with the longitudinal central axis of the fluid duct.

10. Use according to claim 7, wherein the surface to be descaled in relation to the flat jet nozzle is moved in an indexing direction which is parallel with the surface, wherein the first rotation movement and the second rotation movement are mutually adapted such that the flat jet generated by the flat jet nozzle is always disposed at an angle of 0° to ±45°, in particular so as to be perpendicular, to the indexing direction.

11. A method of descaling metal parts using a flat jet nozzle for removing material or soil by means of a high-pressure liquid jet at a pressure range of more than 100 bar, the flat jet nozzle having a nozzle housing, wherein the nozzle housing forms a fluid duct having an exit opening, wherein the fluid duct up to the exit opening is configured so as to be concentric with a longitudinal central axis of the fluid duct, and wherein the exit opening has an elongate shape having a comparatively long main axis and a comparatively short subsidiary axis, wherein a plane in which the comparatively long main axis lies and which is disposed so as to be perpendicular to the comparatively short subsidiary axis intersects the longitudinal central axis and in relation to the longitudinal central axis encloses an angle between 5° and 175° wherein the exit opening is shaped and arranged such that a plane of the delivered flat jet, that thus lies so as to be approximately centric within the delivered flat jet, is disposed so as to be oblique or perpendicular to the longitudinal central axis and so as to intercept the longitudinal central axis.

12. The method according to claim 11, including a first rotation movement of the flat jet nozzle about a first rotation axis which is disposed so as to be perpendicular to a surface of the metal parts to be descaled and so as to be spaced apart from the longitudinal central axis of the fluid duct.

13. The method according to claim 12, including a second rotation movement of the flat jet nozzle about a second rotation axis, wherein the second rotation axis is disposed so as to be spaced apart from the first rotation axis and so as to likewise be perpendicular to a surface of the metal parts to be descaled.

14. The method according to claim 13, wherein the second rotation axis coincides with the longitudinal central axis of the fluid duct.

15. The method according to claim 9, wherein the surface to be descaled in relation to the flat jet nozzle is moved in an indexing direction which is parallel with the surface, wherein the first rotation movement and the second rotation movement are mutually adapted such that the flat jet generated by the flat jet nozzle is always disposed at an angle of 0° to ±45°, in particular so as to be perpendicular, to the indexing direction.
